(19) United States
(12) Patent Application Publication
(10) Pub. No.: US 2024/0028070 A1
(43) Pub. Date: Jan. 25, 2024

(54) Coatings for Textured Glass

(71) Applicant: Apple Inc., Cupertino, CA (US)

(72) Inventors: Laura S Connelly, San Francisco, CA (US); Que Anh S Nguyen, San Jose, CA (US); Matthew S Rogers, San Jose, CA (US); Tyler R Roschuk, San Jose, CA (US)

(21) Appl. No.: 18/311,118

(22) Filed: May 2, 2023

Related U.S. Application Data
(60) Provisional application No. 63/391,638, filed on Jul. 22, 2022.

(51) Int. Cl. G06F 1/16; C03C 17/22; C03C 17/23; C03C 17/34

(52) U.S. Cl. CPC G06F 1/1601; G06F 1/1626; C03C 17/225; C03C 17/23; C03C 17/3435; G06F 2200/1633

(57) ABSTRACT

Electronic devices may be provided with optical components such as displays and sensors that emit and/or detect visible and/or infrared light. The optical components may be mounted in a housing and covered by a textured glass cover layer. The textured glass cover layer may have an antireflection coating formed from a stack of alternating higher index and lower index inorganic dielectric layers. An outermost one of the inorganic dielectric layers may have a hardness greater than quartz to help the antireflection coating resist abrasion. The coating may optionally include a layer of diamond-like carbon to reduce friction and an oleophobic polymer coating to resist fingerprint smudging.

This application claims the benefit of provisional patent application No. 63/391,638, filed Jul. 22, 2022, which is hereby incorporated by reference herein in its entirety.

### FIELD

This relates generally to electronic devices, and, more particularly, to electronic devices with glass structures.

### BACKGROUND

Electronic devices such as tablet computers may include glass structures. For example, a tablet computer may have a glass display cover layer. Display cover layers may sometimes be provided with surface texture to reduce glare.

### SUMMARY

Electronic devices may be provided with optical components such as displays and sensors that emit and/or detect visible and/or infrared light. The optical components may be mounted in a housing and covered by a glass cover layer. Some or all of the surface of the glass cover layer may be textured. The textured glass cover layer may help suppress glare.

To enhance light transmission, the textured glass cover layer may have an antireflection coating. The antireflection coating may be formed from a stack of alternating higher-index and lower-index inorganic dielectric layers. An outermost one of the higher-index inorganic dielectric layers may have a hardness greater than quartz to help the antireflection coating resist abrasion and may optionally be coated with a thin layer of diamond-like carbon to reduce friction and an oleophobic polymer coating. The oleophobic polymer coating may resist fingerprint smudging and decrease friction.

### BRIEF DESCRIPTION OF THE DRAWINGS

FIG. 1 is a side view of an illustrative electronic device in accordance with an embodiment.

FIGS. 2 and 3 are cross-sectional side views of illustrative antireflection coatings in accordance with embodiments.

### DETAILED DESCRIPTION

An electronic device may be provided with optical components. The optical components may include displays and may include sensor components. Transparent structures such as one or more layers of glass, sapphire or other crystalline material, transparent ceramic, polymer, and/or other transparent layers may overlap optical components. In an illustrative configuration, a glass layer may be formed over a display and other optical components. The display, which may sometimes be referred to as a pixel array or display panel, may be formed from a light-emitting diode display panel (e.g., an organic light-emitting diode display panel) or other display. The optical components that are covered by the glass layer may include sensors and other components that emit and/or receive visible and/or infrared light through the glass layer. The glass layer may optionally be chemically strengthened.

The glass layer may help protect overlapped components from damage and may therefore sometimes be referred to as a cover layer (e.g., a display cover layer, an optical component cover layer, a protective cover layer, a protective glass layer, etc.). The outer surface of the glass layer may be textured to help reduce glare from light reflections. The texture on the glass layer may also serve to reduce friction as external objects such as computer styluses and fingers slide across the glass layer.

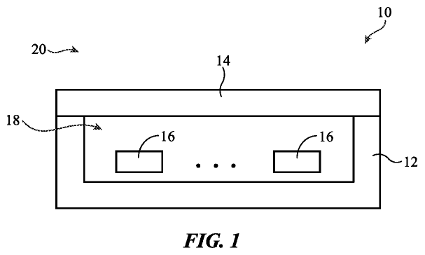

A cross-sectional side view of an illustrative electronic device with a transparent protective layer such as a glass layer is shown in FIG. 1. As shown in FIG. 1, device 10 may have a housing such as housing 12. Housing 12 may be formed from structures of metal, polymer, ceramic, glass, fabric, and/or other materials. Glass layer 14 may be coupled to housing 12. Housing 12 and glass layer 14 may separate interior region 18 from exterior region 20 surrounding device 10. Device 10 may be a portable electronic device such as a laptop computer, a cellular telephone, a tablet computer, a wristwatch or other wearable device, or other portable electronic device or may be a desktop computer, computer monitor, television, or other electronic equipment.

Components 16 may be mounted in interior region 18. Components 16 may include electrical components such as a battery, integrated circuits, sensors, processing circuitry, storage, input-output devices, and/or other components. In an illustrative configuration, components 16 include a display that is configured to display images. The display may be overlapped by some or all of glass layer 14, so that the images on the display are visible through layer 14 (e.g., so that layer 14 serves as a display cover layer). Components 16 may also include optical components that emit and/or receive visible and/or infrared light such as visible and infrared image sensors, infrared and/or visible light sources (e.g., infrared structured light sources for three-dimensional cameras that include infrared image sensors, infrared and/or visible light sources for infrared and/or visible camera illumination, infrared emitters for infrared proximity sensors, light-emitting diodes that serve as status indicators, etc.), light sensors such as photodetectors (e.g., photodetectors in color and/or monochrome ambient light sensors, photodetectors in infrared proximity sensors that emit infrared light and measured corresponding reflected infrared light to determine whether an external object is within vicinity of the proximity detectors, photodetectors in an optical fingerprint detector, other infrared and/or visible light sensors, etc.), and/or other components that operate using light that passes through layer 14. In addition to overlapping a display that presents images, glass layer 14 may overlap one or more of these other optical components.

To prevent undesired glare (e.g., harsh specular reflections of interior and/or exterior lighting from the surface of glass layer 14), glass layer 14 may have an exterior surface that is textured. Glass layer 14 may, as an example, be treated using sand blasting, laser exposure, dry and/or wet etching, reactive ion etching, surface abrasion, and/or other roughening processes to produce a desired surface texture. Combinations of texturing techniques such as these may also be used. For example, sandblasting may be used to create a course texture and a subsequent NaOH etch may be used to refine and smooth the sandblasted surface to form a desired anti-glare texture for layer 14.

The surface texture that is formed on the exterior surface of layer 14 may reduce glare will allowing glass layer 14 to remain transparent. In an illustrative configuration, the surface texture on glass layer 14 may be characterized by pattern of peaks (sometimes referred to as bumps or protrusions) and valleys (recessed portions between the bumps), where the mean peak amplitude (sometimes referred to as the mean peak-to-valley height, bump height, or protrusion height) of the textured glass surface is 0.13-0.23 microns, at least 0.05 microns, at least 0.08 microns, at least 0.1 microns, less than 0.5 microns, less than 0.4 microns, less than 0.3 microns, 0.05-1.0 microns, 0.07-0.5 microns, etc. and where the mean spacing between peaks (sometimes referred to as the pitch, peak pitch, bump pitch, etc.) is 10-20 microns, at least 3 microns, at least 5 microns, at least 7 microns, less than 60 microns, less than 30 microns, less than 25 microns, less than 20 microns, 5-40 microns, 3-60 microns, and/or other suitable pitch.

The textured surface of glass layer 14 faces exterior region 20. The opposing inner surface of layer 14 may be untextured (e.g., polished). To help reduce light reflections at the textured surface and thereby enhance light transmission through layer 14, the textured surface of layer 14 may be provided with an antireflection coating. The inner surface may also have an antireflection coating, if desired.

The antireflection coating on the textured surface may be formed from a stack of alternating higher-refractive-index and lower-refractive-index layers that form a thin-film interference filter with a desired transmission band. The layers of the antireflection coating may be inorganic dielectric layers such as silicon oxide, silicon oxynitride, metal oxides (e.g., zirconia, titania, niobium oxide, alumina, etc.) and/or other dielectric layers, so the thin-film interference filter may sometimes be referred to as being formed from a dielectric stack. In an illustrative configuration, the refractive index values of the layers of the dielectric stack, the thicknesses of the layers of the dielectric stack, and/or the number of layers in the dielectric stack are configured to provide a high light transmission characteristic (e.g., at least 97%, at least 98%, 99%, at least 99.5%, etc.) over visible wavelengths (e.g., from 400 nm to 700 nm) and near infrared wavelengths (e.g., 700 nm to 1500 nm, or 700 nm to 1300 nm, as examples). In this way, a visible-light-transmitting-and-infrared-light-transmitting antireflection coating for glass layer 14 may be formed that enhances the performance of the infrared and/or visible light optical components that are overlapped by layer 14 (e.g., an infrared image sensor for a three-dimensional camera, a visible light image sensor, a display, a proximity sensor, an ambient light sensor, a fingerprint reader, etc.).

To enhance durability (e.g., to prevent dust particles and/or hard media on the surface of layer 14 from causing abrasion to the textured surface of layer 14 when a keyboard accessory, computer stylus, finger, or other external object rubs against the textured surface), it may be desirable to form the antireflection coating at least partly from hard dielectric materials. Dust particles sometimes contain sand (quartz), which generally has a Vickers hardness of 1200. To enhance abrasion resistance, the outer layer of the antireflection coating may be formed from a material that is harder than commonly encountered quartz dust particles. For example, the outermost layer of the antireflection coating may be harder than quartz (e.g., the outermost layer may have a Vickers hardness of at least 1250, at least 1300, at least 1350, at least 1400, or other suitable hardness). Examples of hard coating materials that may be used as the outermost antireflection layer material include silicon nitride (Vickers hardness of 1700-2200) and silicon oxynitride (hardness dependent on stoichiometry). In some configurations, an additional friction-reduction coating of diamond-like carbon (Vickers hardness of 5000-9000) may be applied (e.g., a thin diamond-like-carbon coating may be applied on top of a hard outer antireflection coating layer such as a silicon nitride or silicon oxynitride layer).

Silicon nitride and silicon oxynitride (with an appropriate stoichiometry) are harder than dust particles (as is diamond-like carbon) and therefore help resist dust particle abrasion, which may particularly be an issue with textured surfaces that are exposed to dust particles having diameters that are comparable to the size of the texture (e.g., diameters comparable to the mean peak-to-valley distance and/or mean pitch of the protrusions forming the texture on layer 14). Other hard materials (e.g., other hard inorganic dielectric layers) may be formed on layer 14, if desired. The use of silicon nitride and silicon oxynitride as the topmost inorganic dielectric material in the high/low index layers of the dielectric stack of the antireflection coating is illustrative.

Although the outermost layer in the dielectric stack of the antireflection coating is formed from a hard inorganic dielectric material, an additional organic thin-film layer that serves to resist fingerprint smudges may, if desired, be deposited on top of the outermost hard layer (or on top of the thin diamond-like coating in arrangements where the diamond-like coating is formed at the top of the dielectric stack to reduce friction). For example, the outermost hard inorganic dielectric layer in the dielectric stack of the antireflection coating (or the diamond-like coating on top of the stack) may be coated with an oleophobic coating such a fluoropolymer layer of about 5 nm to 25 nm in thickness to help layer 14 resist smudging from fingerprints.

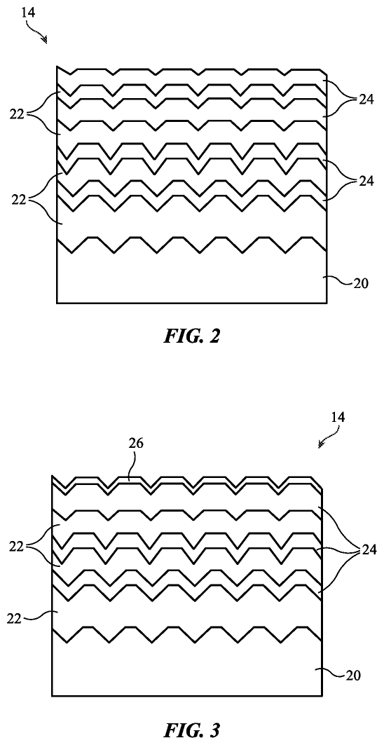

Illustrative antireflection coatings for glass layer 14 are shown in FIGS. 2 and 3.

As shown in FIGS. 2 and 3, glass layer 20 may be coated with an antireflection coating formed from a stack of thin-film inorganic dielectric layers. The total number of layers in the antireflection coating may be at least 2, at least 4, at least 6, at least 10, less than 200, less than 100, etc. The interfaces between layers may be abrupt or may be characterized by composition gradients. The thicknesses of the layers in the antireflection coating may have thicknesses of 5-1500 nm or may have smaller or larger thickness values. The refractive index values of the layers of the coating may alternate between higher and lower values. For example, the first layer on the textured surface of glass layer 20 may have a higher index value, the second layer may have a lower index value, the third layer may have a higher index value, and so forth. The stack preferably ends with a hard outer layer (which may be, for example, a higher index value layer such as a layer of silicon nitride or silicon oxynitride). The thickness of the outermost inorganic dielectric layer in the dielectric stack of the antireflection coating may be, as an example, at least 10 nm, at least 20 nm, at least 30 nm, at least 50 nm, or at least 70 nm (as examples). Thinner coatings (e.g., 10-20 nm) may exhibit less wear resistance than thicker coatings (e.g., coatings thicker than 70 nm), but thinner coatings may help enhance antireflection coating optical performance (reflection reductions).

Consider, as an example, the illustrative coating of FIG. 2. As shown in FIG. 2, layers 22 may alternate with layers 24. Layers 22 may be, for example, lower-refractive-index layers of silicon oxide (refractive index 1.46) and layers 24 may be higher-refractive-index layers of silicon nitride (refractive index 2.0) or silicon oxynitride (e.g., layers 24 may be harder and may have higher refractive index values than layers 22). The topmost (outermost) layer of dielectric in the coating in this example is a silicon nitride layer, which is harder than quartz and therefore sufficiently hard to resist abrasion from dust particles. The lowermost layer of dielectric in the coating may be one of layers 22 (e.g., a silicon oxide layer or other lower-refractive-index layer formed directly on layer 20) or the lowermost of layers 22 may be omitted (e.g., the lowermost layer of dielectric in the coating may be one of layers 24 formed directly on layer 20).

If desired, the stack of dielectric layers in the coating may include three or more or four or more different dielectrics with different refractive indices. As one example, layers 22 may be silicon oxide layers, whereas one or more of layers 24 may be formed from silicon nitride and one or more layers 24 may be formed from silicon oxynitride.

In the example of FIG. 3, layers 22 may again be silicon oxide layers and layers 24 may again by silicon nitride or silicon oxynitride layers (as examples). To help reduce friction (e.g., so that a computer stylus can smoothly slide across layer 14), the topmost of layers 24 may be coated with an additional hard inorganic dielectric coating such as a thin coating of diamond-like carbon (coating layer 26). The hardness of layer 26 may help enhance abrasion resistance for the textured surface of layer 14. To avoid excess light absorption by coating layer 26, the thickness of coating layer 26 may be less than 40 nm or less than 20 nm (as examples). In configurations in which layer 26 is formed on one of layers 24 as shown in FIG. 3, the second-to-outermost inorganic dielectric layer may be a higher-refractive-index layer and may have a hardness that is greater than quartz (e.g., a Vickers hardness of at least 1300, etc.).

In some embodiments, sensors may gather personal user information. To ensure that the privacy of users is preserved, all applicable privacy regulations should be met or exceeded and best practices for handling of personal user information should be followed. Users may be permitted to control the use of their personal information in accordance with their preferences.

The foregoing is merely illustrative and various modifications can be made to the described embodiments. The foregoing embodiments may be implemented individually or in any combination.

What is claimed is:

1. An electronic device, comprising:
a housing; and
a glass layer that is coupled to the housing, wherein the glass layer has a textured surface with an antireflection coating and wherein the antireflection coating has an outermost inorganic dielectric layer with a hardness greater than quartz.

2. The electronic device defined in claim 1 further comprising a light source in the housing that is configured to emit light through the glass layer.

3. The electronic device defined in claim 1 further comprising a light sensor that is configured to detect light through the glass layer.

4. The electronic device defined in claim 1 further comprising a display configured to emit light through the glass layer.

5. The electronic device defined in claim 4 further comprising an infrared light sensor configured to detect infrared light through the glass layer.

6. The electronic device defined in claim 5 wherein the antireflection coating comprises a visible-light-transparent-and-infrared-light-transparent antireflection coating.

7. The electronic device defined in claim 6 wherein the antireflection layer comprises a stack of inorganic dielectric layers having alternating first and second refractive index values, wherein the second refractive index value is higher than the first refractive index value, and wherein one of the inorganic dielectric layers of the second refractive index value forms the outermost inorganic dielectric layer with the hardness greater than quartz.

8. The electronic device defined in claim 7 wherein the inorganic dielectric layers of the second refractive index value comprise silicon nitride layers.

9. The electronic device defined in claim 7 wherein the inorganic dielectric layers of the second refractive index value comprise silicon oxynitride layers.

10. The electronic device defined in claim 7 wherein the inorganic dielectric layers of the first refractive index value comprise silicon oxide layers.

11. The electronic device defined in claim 7 wherein one of the inorganic dielectric layers of the first refractive index value is formed directly on the textured surface.

12. The electronic device defined in claim 7 wherein one of the inorganic dielectric layers of the second refractive index value is formed directly on the textured surface.

13. The electronic device defined in claim 6 wherein the antireflection layer comprises a stack of inorganic dielectric layers including one or more inorganic dielectric layers of a first refractive index, one or more inorganic dielectric layers of a second refractive index that is different than the first refractive index, and one or more inorganic dielectric layers of a third refractive index that is different than the first and second refractive indices.

14. The electronic device defined in claim 1 wherein the outermost inorganic dielectric layer comprises a diamond-like-carbon layer.

15. An electronic device, comprising:
a housing;
a display in the housing; and
a glass display cover layer that is coupled to the housing and that overlaps the display, wherein the glass display cover layer has a textured surface with an antireflection coating and wherein the antireflection coating has an outermost inorganic dielectric layer with a Vickers hardness of at least 1300.

16. The electronic device defined in claim 15 wherein the outermost inorganic dielectric layer comprises silicon nitride.

17. The electronic device defined in claim 15 wherein the outermost inorganic dielectric layer comprises silicon oxynitride.

18. The electronic device defined in claim 15 wherein the outermost inorganic dielectric layer comprises diamond-like carbon.

19. The electronic device defined in claim 18 wherein the antireflection coating comprises a second-to-outermost inorganic dielectric layer under the outermost inorganic dielectric layer and wherein the second-to-outermost inorganic dielectric layer has a Vickers hardness of at least 1300.

20. The electronic device defined in claim 15 wherein the antireflection layer comprises a thin-film interference filter formed from a stack of inorganic dielectric layers configured to transmit visible light and infrared light.

21. The electronic device defined in claim 15 further comprising an infrared image sensor configured to receive infrared light through the glass display cover layer.

22. The electronic device defined in claim 15 wherein the textured surface has bumps with a mean bump height of 0.05-1.0 microns and a mean bump pitch of 5-40 microns.

23. A display cover layer operable to cover an optical component in an electronic device, comprising:
a textured glass layer having bumps with a mean bump height of 0.05-1.0 microns and a mean bump pitch of 5-40 microns; and
a stack of inorganic dielectric layers on the textured glass layer configured to form a visible-light-transmitting-and-infrared-light-transmitting antireflection coating, wherein the stack of inorganic dielectric layers has alternating higher refractive index layers and lower refractive index layers and wherein an outermost layer of the inorganic dielectric layers has a Vickers hardness of at least 1300.
